(19) United States
(12) Patent Application Publication
(10) Pub. No.: US 2016/0019101 A1
(43) Pub. Date: Jan. 21, 2016

(54) CONTENT GENERATION AND TRACKING APPLICATION, ENGINE, SYSTEM AND METHOD

(71) Applicants: Ryan Steelberg, Irvine, CA (US); Chad Steelberg, Newport, CA (US)

(72) Inventors: Ryan Steelberg, Irvine, CA (US); Chad Steelberg, Newport, CA (US)

(21) Appl. No.: 14/805,132

(22) Filed: Jul. 21, 2015

Related U.S. Application Data
(60) Provisional application No. 62/027,070, filed on Jul. 21, 2014.

(51) Int. Cl. G06F 9/54; G10L 15/26

(52) U.S. Cl. CPC G06F 9/541; G10L 15/26

(57) ABSTRACT

The present invention relates to the transcription of audio, and, more particularly, to an engine, system and method of providing audio transcriptions for use in content resources.

### CROSS REFERENCE TO RELATED APPLICATIONS

This application claims priority to U.S. Provisional Ser. No. 62/027,070, filed Jul. 21, 2104, which is hereby incorporated by reference in its entirety.

### BACKGROUND

1. Field of the Invention

The present invention relates to the transcription of audio, and, more particularly, to an engine, system and method of providing audio transcriptions for use in content resources.

2. Background of the Invention

There exists a need for an engine, system and method that provides audio transcriptions for use in content resources.

### SUMMARY

The present invention includes at least a computer-implemented engine, system and method for generating audio transcriptions for use in content resources.

Thus, the present invention provides an engine, system and method that provides audio transcriptions for use in content resources. It is to be understood that both the foregoing general description and the following detailed description are exemplary and explanatory, and are intended to provide further explanation of the invention as discussed herein throughout.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrates an aspect of an exemplary embodiment of the present invention; and

FIG. 5 illustrates an aspect of an exemplary embodiment of the present invention.

### DETAILED DESCRIPTION

Computer-implemented platforms, engines, systems and methods of use are disclosed that provide networked access to a plurality of types of digital content, including but not limited to video, audio, metadata, interactive and document content, and that track, deliver manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

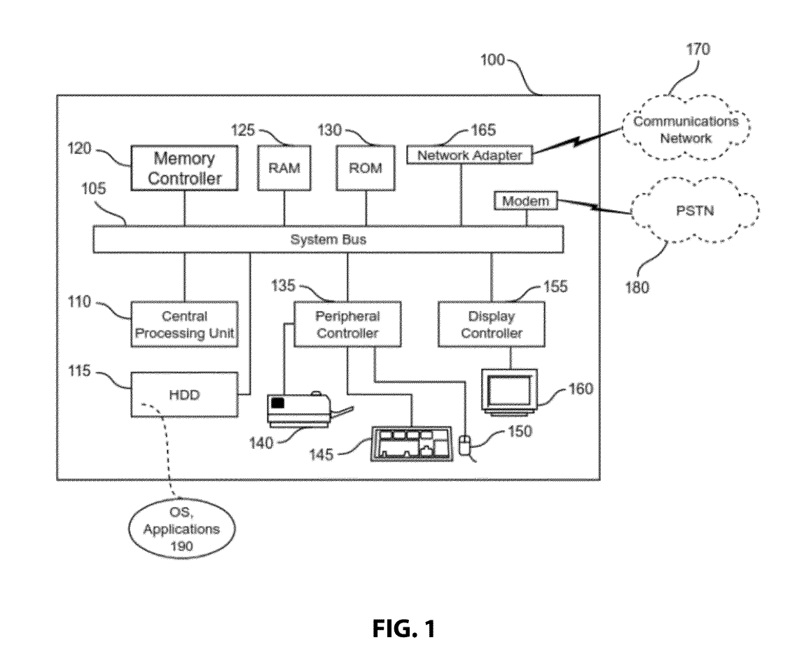

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120.

Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

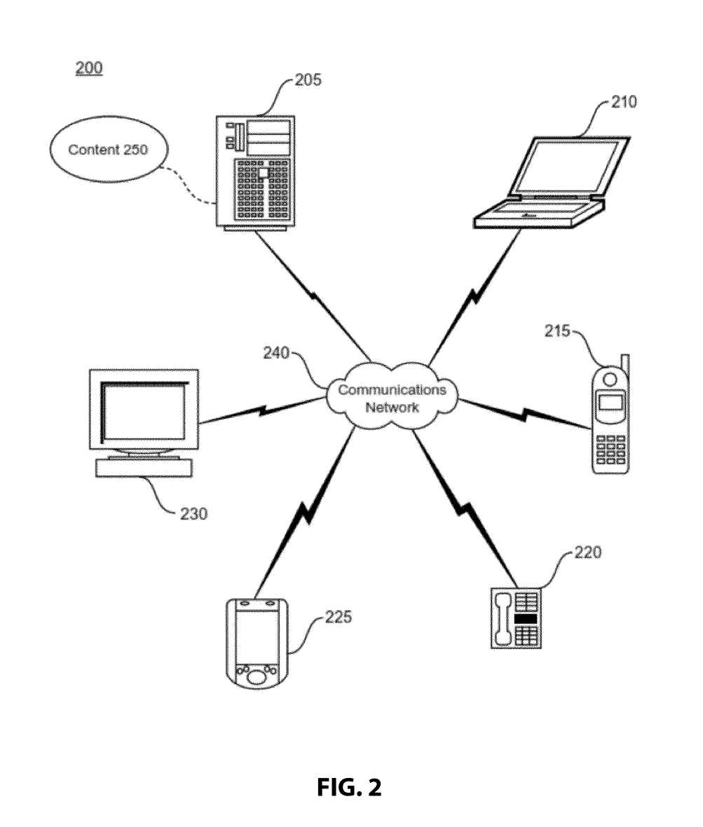

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

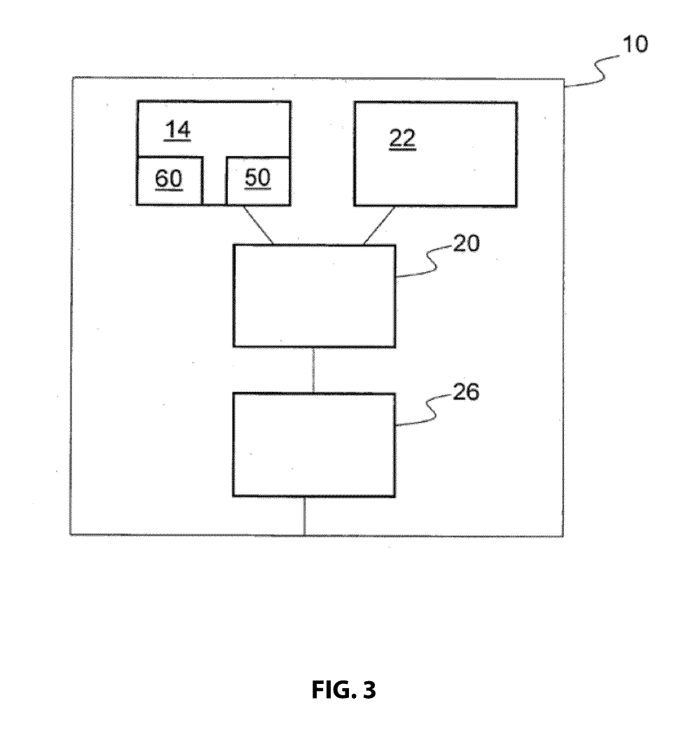

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 3, may include a vault 12 that provides media assets 14 and integration of media assets without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, late stage binding of the ad 22 and media asset 16 upon delivery to strongest target consumers, and delivery of the ad 22 and the dynamic media asset 16 from the vault to an advertiser or advertising server, which then places the mash up of the ad and media asset. Needless to say, the aforementioned engines may be included in the present invention in any combination of one or more engines. Ad requests 22 may be made via an “ad wizard” using ad templates, as will be apparent to those skilled in the art.

The vault captures certain brands and information related thereto, such as use rules, in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and may place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography, demographic and daypart information. Gathered data intelligence may be used as individual properties in conjunction with each other to form or produce the level of intelligence needed to achieve the desired efficiencies. By way of further example, data intelligence may also include information regarding the number of impressions an ad has received, and/or the elapsed time between an impression or a click. Additionally, data intelligence may include information regarding valuable ads or creatives that should have been, but were not, placed, such as, for example, available ad slots online, on television, on radio, or the like, into which a competitor or competitive product or service, was placed. Thereby, data intelligence provides for a reevaluation of value, thus enabling an advertiser to not miss optimal opportunities more than once.

Thus, utilizing data intelligence allows the delivery engine 26 to optimize targeting to new and the equivalent of past targets. Optimization may include efficiencies of time and control over redundancies and ad targeting, for example. Optimization allows for the prediction of probable impressions or clicks that a certain ad or creative may receive when, for example, or that similar past ads have received, for example, with consideration of certain factors, such as demographic and geographic, for example. A prediction may also be made regarding the efficiency of paid searches, and/or may be further contrasted with, for example, display ads. Such information, as drawn from the data intelligence, may also allow for the higher success rates related to redundant ad placement based on prior behavior of a particular audience, for example. The same can be true for the avoidance of redundancy when, for example, data intelligence may be used to keep certain ads or creatives from repeatedly reaching an audience with, for example, low click-through rates. Redundancy avoidance may also include the avoidance of competing ads or creatives, whether or not placed for the same entity. For example, date intelligence may monitor the number of “avails” of prime time tv characters wearing sports jerseys, and based on Neilsen ratings, the exposures gained by those advertisers placing to such avails. Thus, data intelligence may suggest an optimal value of placing to such avails for a sports jersey seller for future ones of such avails.

The delivery engine 26 may also choose to deactivate and/or modify certain creatives based on data intelligence and/or user direction. The delivery engine may include fulfillment offline, such as on tv, for example. By way of non-limiting example, the data intelligence may be collected from several ad or creative types over any number of varying media formats, allowing for even more sophisticated optimization, and ultimately delivery, based on the allocation of impressions and clicks in the various media formats. Media formats may include, but are not limited to, internet, t.v., radio, mobile devices, kiosks, billboards, product placements, and print. By further way of non-limiting example, data intelligence gathered during a run of a creative on the radio may affect the play of an ad on the internet, for example. The delivery engine 26 may additionally allow for the interplay between data intelligence and real time metrics or community-based information. This real time intelligence gathering may also be used to calibrate a campaign(s) of multiple ads or creatives. By way of non-limiting example only, a campaign of with several creative versions may be measured based on gathered data intelligence and optimized to improve, for example, click-through and/or viewership/listenership. Such optimization may thus be done in real time and over multiple media types. The optimization may, by way of further non-limiting example, call for the addition of ads or creatives not currently within the campaign(s), thus suggesting what type of ads or creatives are required for optimization regardless of whether or not the ads or creatives reside in inventory.

Optimization of ads and creatives increases the value of ad and creative inventory and may, for example, provide for greater value pre and post delivery. The data intelligence may also allow for real-time valuations based on pre-existing and predicted avails, thus maximizing the value of the eventual placed ad or ad/creative inventory. Value can be also maximized for premium and non-premium content. Functionality within the delivery engine 26 may also allow for variable rate sampling and frequency cap forecasting.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

Further, the present invention may facilitate the placement of assets, creatives, and/or products in a variety of display mediums. More specifically, in an embodiment of the present invention, the delivery engine 26 may facilitate the placement of brands in various media through the aforementioned marketplace of avails offered for sale. This marketplace brings together both advertisers and media owners allowing for the matching of products with appropriate placements offered for sale by media owners within the created media. Created media may include TV, film, music, advertising, video games, software products, on-line content, and events, for example.

Product placements, as they are generally referred to in the industry, are “avails” as discussed herein and foster brand recall, feeling and purchase intent. Placements may include visual avails, including prop usage and background placements, in created media as well as in dialogue mentions. The present invention joins together media owners, studios, production companies, and “below-the-line” production staff (collectively “media owners”) with marketers, product placement agencies and advertising agencies (collectively “placement owners”). The ability of media owners and placement owners to participate in a real-time marketplace where assets may be bought and sold may provide a more efficient exchange of assets as well as providing a better opportunity to exploit assets of lesser value by reducing transaction costs.

In an embodiment of the present invention, the placements offered for sale may themselves be considered assets within the present invention. Working in conjunction with the brand association and recommendation engine 20, the present invention may connect, for example, a product with a placement, and may ultimately deliver through the delivery engine 26, for example. For example, the owner of placements in a television show may offer for sale at least one placement in a designated show at a particular point during the show. A value may be assigned to the placement based on the type of placement offered and the number of views the placement is expected to have, for example. A buyer or media owner may review the parameters of the placement and purchase the placement for use with a particular asset. If the placement is not well understood through textual explanation or visual cues, the placement, with or without usage of the asset, may be reviewed by the media owner before final acceptance of the placement occurs.

Furthermore, the present invention may track the various metrics surrounding the placement before and after placement. Such metrics may allow for a more refined valuing of the placement offered and may allow for a variety of payment options between the media and placement owners, for example. The metrics tracked for this purpose may be viewership ratings, demographic response, syndication rights, content and/or genre of the media, and delivery method on which the media is based or is likely to be viewed or heard, for example. Such an array of metrics not only allows for a refined estimation of value for the original placement offer, but may also facilitate the offering of deferred payment structured placements. For example, a placement owner my collect a fee from a media owner and may collect a continuous fee based on the repeating play nature of re-runs and/or syndication, for example.

The metrics gathered may also produce a “ratings score” which may be used by the media holder to value and plan potential placements across a spectrum of available and non-available placements. The ratings score thus takes into account a comparison of placements available through the provided marketplace with those otherwise made available through traditional outlets. This outward view to the total of available placements in the industry at large provides users of the system with a more refined and objective understanding of the value and coverage of the placements being made, thus increasing the confidence users of the marketplace have in the valuations made by the system.

Furthermore, the recommendation engine 20 may provide the user with suggested placements or media which may be optimal in terms of maximizing the value and coverage of each product placement. The recommendations made may be approved or denied by a user, and may be modified in that more than one placement option may be suggested. For example, the recommendation engine 20 may recommend a “fall” schedule of placements that would account for previous placements and budgets applied by the media owner, and the availability and prior consents by the placement owner. The recommendation engine 20 may also query each party to understand current needs and constraints in order to suggest a placement schedule in-line with known parameters. As would be expected, any direct input by users of the system may be used by the recommendation engine 20 to suggest various placements at any point during a given period. For example, if there is a discounted placement that would fit a particular product, the media owner may be alerted to the favorable placement.

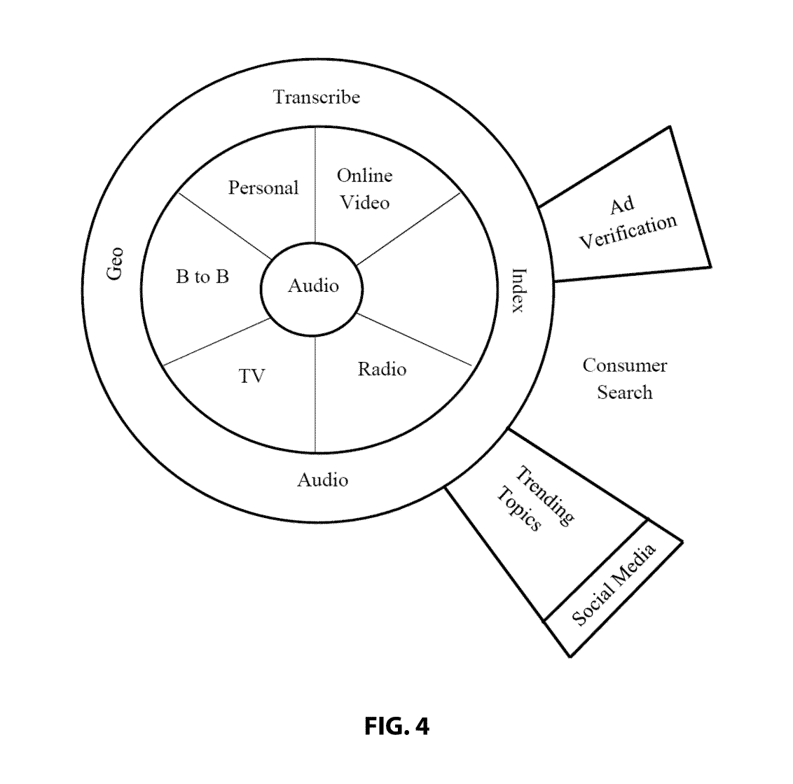

In an embodiment of the present invention, and as illustrated in FIG. 4, a method of providing content may be provided, which may comprise receiving a stream comprising media content, chunking the received stream into media snippets of a predetermined length, wherein each media snippet is keyed to at least one keyword, automatically, and substantially commensurate with said receiving of the stream, generating a transcript for each of the media snippets, providing the transcript, and the media snippet uniquely corresponded thereto, for access by a user. The media content may also consist of audio and the media content may comprise video, for example. The predetermined length may be one of three, five, or seven minutes, for example. Similarly, the present invention may allow for posting to the cloud and/or providing an html link in a browser window. The present invention may also comprise at least a springing a secondary browser window substantially consisting of a transcript and a search engine results window, responsive to a search by the user. The present invention may also comprise a native providing of the transcript and the media snippet, absent generation of intermediate content to enable said providing.

In an embodiment of the present invention, a method of publishing content may comprise publishing a content stream comprising at least audio content and keywords indicative of the audio content to a transcription engine for transcription of the audio content, matching the audio content uniquely to the transcription, allowing for the providing of at least the audio content and, distinct therefrom, the matched transcription, to a requesting user at a time substantially commensurate with said publishing.

In an embodiment of the present invention, a method of providing social media content may comprise receiving a plurality of streams, each comprising media content, assessing at least one keyword relevant to each of the plurality of streams, programmatically channelizing each of the plurality of received streams into a plurality of channels based upon the respective at least one keyword, automatically, and substantially commensurate in time with said programmatically channelizing, generating a transcript for each of the channels, providing the transcript, and the channel uniquely corresponded thereto, for access by a user as the social media content. Such an embodiment may also allow for assessing at least one trend according to appearances of the at least one keyword across multiple ones of the plurality of streams. The appearances may comprise a quantitative number of appearances and or a qualitative assessment of appearances.

In an embodiment of the present invention, a method of receiving content may comprising receiving a plurality of streams, each comprising media content, receiving an indication of at least one keyword relevant to each of the plurality of streams, wherein the indication further comprises at least one trend related to the at least one keyword, programmatically channelizing, for ultimate consumption by a social media user, of each of the plurality of received streams into a plurality of channels based upon the respective at least one trend, receiving a transcript for each of the channels for ultimate consumption by the social media user substantially commensurate in time with the ultimate consumption by the social media user of the channel.

The present invention may provide a non-transitory computing system comprising code for execution by at least one computing processor, wherein execution of the code by the at least one processor provides an audio content layer capable of receiving a plurality of audio streams, a broadcast layer capable of transceiving broadcasted ones of the plurality of audio streams over at least three different broadcast means, an application programming interface (API) layer capable of manipulating broadcasted ones of the plurality of audio streams to provide a plurality of end-user applications, wherein the manipulating comprises at least a transcription of at least portions of each of the broadcasted ones of the plurality of audio streams and at least one selected from the group consisting of a quantitative appearance in the portions of each of the broadcasted ones of the plurality of audio streams, a qualitative appearance in the portions of each of the broadcasted ones of the plurality of audio streams, a geography of interest in the portions of each of the broadcasted ones of the plurality of audio streams, a geography of generation of the portions of each of the broadcasted ones of the plurality of audio streams, an audience profile of the portions of each of the broadcasted ones of the plurality of audio streams, and a verification of the content of the portions of each of the broadcasted ones of the plurality of audio streams.

The present invention may provide a non-transitory computing system comprising code for execution by at least one computing processor, wherein execution of the code by the at least one processor provides a media asset conversion comprising the steps of receiving a stream comprising media content, chunking the received stream into media snippets of a predetermined length, wherein each media snippet is keyed to at least one keyword, automatically, and substantially commensurate with said receiving of the stream, generating a transcript for each of the media snippets, providing the transcript, and the media snippet uniquely corresponded thereto, for access by a user.

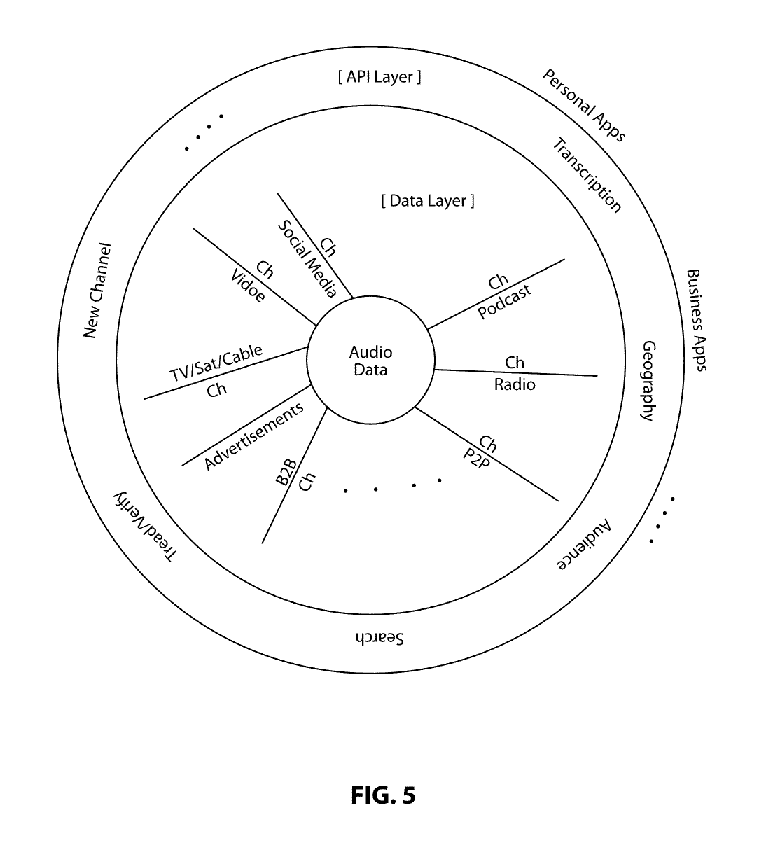

As illustrated with regard to the architectural illustration of FIG. 5, the instant invention may include a data layer comprised of audio data. This data layer may incorporate said audio data from any one or more of a variety of sources that will be understood to those skilled in the art, including but not limited to online audio broadcasts (i.e., podcasts, etc.); online video broadcasts; streamed broadcasts; offline radio broadcasts (i.e., AM, FM, XM, HD); television, satellite, cable and narrowcast programming; and person-to-person, business-to-consumer, and business-to-business broadcasts and communications.

Around the data layer may preferably be provided an application programming interface (API) layer. Included in this layer may be one or more tools, filters, hooks, or the like to allow for the generation of applications, “apps,” reports, and the like (hereinafter “apps”), centric to the audio data of the data layer. Of course, these apps may additionally access available information, such as may be related to the audio data. By way of non-limiting example, related information such as the audience size, audience demographics, audience location or reach, popularity, competitive standing, talent, or the like of a given program or channel generating the audio data may be linked to the audio data, and/or may be otherwise accessible to and from the API layer.

Additionally, a plurality of generated data relative to the audio data may be provided in conjunction with the API layer. For example, transcriptions, meta data (such as may relate the audio data to the related information for a particular program, channel, etc.), geographic linking, URL or like domain information, channel specific information, program specific information, audience information, search engines and/or searching capabilities, or the like may be “imprinted” with the respective audio data, and thereafter this generated data may be made available in the API layer. As such, the generated data may more readily allow, for example and with particularity, for monetization of the audio data. The generated information may be made available via dedicated service servers to those working in the API layer, and/or may be made available as a “white label” or cloud-based service, for example.

Thereby, a plurality of apps may be provided from the API layer that makes use of the native audio data, the related information, and/or the generated data. For example, consumer searches related to audio broadcasts may be made available; trending reports and analysis may be provided in relation to audio (and video) data; verification of placement for advertising, and/or advertisement pricing, may be provided or enabled; programmatic channels related to topics, persons, fan interests, or the like may be provided, such as for integration with social media; and myriad other services may be provided using the plurality of apps.

For example, an agency/broadcaster interface app may be provided. In such an embodiment, an agent may search “Richard Sherman.” This search might return hits of involvement of anyone named Richard Sherman (such as the NFL player) in a broadcast involving audio. Further, accessing the hits may preferably provide a searchable transcript of the selected appearance. Also provided may be the audio and/or video of the selected appearance. The audio or video may be provided via any number of means, such as in-window in its native environment (i.e., such as on the website at which the content was initially provided, and such as with the ads and associated content from the native window) with a “split window” providing the transcript (wherein the transcript window may be corresponded in time with the audio-video); such as natively in a second window wherein the transcript is provided in the first window; such as “framed” in the native window by the transcript and any ads or content related to the transcript, or the like. Moreover, a transcription may be centrally provided with the audio/video content in a background window, and may be closeable/minimizeable in order to centrally feature the audio/video content only on the screen of the user. Any or all of the foregoing may be provided, for example, via a widget or independent app suitable to provide the referenced transcriptions, and/or one or more apps stemming from the API layer.

In preferred embodiments, this transcription of content may occur and be immediately available to the API layer. In other words, such transcription may be in real time with the generation of the audio/video content, such as via voice-recognition software that continuously monitors the aforementioned audio data feed channels. Correspondingly, the transcription may form an additional content that is related to other content (i.e., the audio/video content), and which may be made available, such as from a storage location (i.e., a media content vault—See Appendix A, incorporated herein as forming part of the present invention), with all interrelated content.

Thus, the present invention may allow for, among other services and apps, brand management of talent. That is, a digital service may be provided based on transcription, wherein appearances of talent may be tracked in heretofore untracked media, and wherein such appearances, and/or the content thereof, may be posted to social media. Moreover, this will allow for a value to be ascribed to a brand. Likewise, it will allow for extended searching of brand mentions, as well as qualitative and quantitative tracking of those mentions. This qualitative and quantitative tracking will, if used in conjunction with a rating system, enable the prescription of a value to a brand. This valuation may be further enhanced by imprinting with the related information and the generated data (i.e., how many people did the transcripted event reach, and where). This valuation can occur and vary in real time using heretofore untracked media, and can additionally allow for review of the occurrence and its transcription as the event occurs. Needless to say, a “brand,” as used herein, may be anything that may have a value ascribed to mentions related to it.

In a specific exemplary illustration of an ad verification, the brand “Subway” may desire an ad injection into 3 different media channels. This context for advertisement has historically been very difficult to track. However, in the instant invention, each channel may be tracked, such as wherein one channel includes an uploaded video from Subway that Subway then tracks the discussion in relation to on social media (i.e., via the generated data). Additionally, the advertiser may repurpose media for ad campaigns, such as for use in other apps or media (i.e., from a podcast to a consumer search app). Yet further, an advertiser may launch various other verticals from the API layer, such as responsive to certain conditions, as may be indicated by the related information and/or the generated data. Further, the advertiser may be enabled to publish any desirable related information to its social media, such as its Twitter feed.

Consequently, the foregoing architecture may allow a continuous scan for any brand in any media. Further, the transcription that may preferably form part of this scan may be generated content unique to and owned/controlled by the instant invention. As such, the inventors hereof envision that like-efforts may be accomplished using intermediate content pages that provide scannable information (such as auto-translated transcriptions of audio content) for scanning by known search engines. More specifically, the present invention may also be provided using the processes discussed throughout, or may similarly be provided by, for example, receiving or providing audio-snippets, such as 5 minutes snippets. These short snippets may then be transcribed in approximately real time. Of course, meta data may also need to be linked to the terms in the transcript to make it searchable. This transcription may then be searched. However, the instant exemplary embodiments are provided using an illustration of generated transcription content without use of an intermediate page, and without need of term-by-term meta data.

As such, the instant architecture may similarly provide channelization of incoming or outgoing transcribed content. For example, a brand may purchase a membership by channel. For example, a first prepackaged app in the API layer may be provided to those members of an advertisers' verification channel; a second app may be provided for tracking of social media, or specifically Twitter, mentions; and a third app may allow for members to create ad campaigns by making ad buys of avails in various types of audio/video content.

As an example of member access to an ad buy channel, a content provider to YouTube may be approached by an advertiser with an offer. For example, based on related data of that user's YouTube channel (i.e., number or demography of followers), a large advertiser, such as McDonald's, may offer a relevant sum, such as $26, for each mention of that advertiser on that user's YouTube channel. Additionally, the transcription referenced herein may allow for real-time verification of placement of the ad in the avail by the advertiser.

The present invention may thus provide, such as in conjunction with typical, known search methods, a true reflection of real time media content provision. Thus, for example, a search of the “Mike & Mike show”, can provide a transcript/results of the radio show, the television show, and web site content. Also, the user may be enabled to “attend” the show in real time, such as by being provided with the audio/video feed of the show in an alternative window, such as is discussed above. On the contrary, in present search methods, a search for the Mike and Mike show will return only a link to the show on its web site (or on its Twitter account, etc.).

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

1-17. (canceled)

18. A method for generating applications, the method comprising:
receiving audio data at a data layer;
providing an application programming interface (API) around the data layer; and
generating, by the API using at least one hardware processor, one or more applications based on the received audio data.

19. The method of claim 18, further comprising:
accessing information related to the received audio data.

20. The method of claim 19, further comprising:
the accessed information comprises audience size, audience demographics, audience location, audience reach, popularity, competitive standing, or talent.

21. The method of claim 20, further comprising:
the accessed information is linked to the received audio data.

22. The method of claim 18, the API layer further comprises:
tools, filters, and hooks.

23. The method of claim 18, further comprising:
the generating of applications further comprises manipulating the audio data by the API layer utilizing at least one of transcriptions and metadata, geographic linking, URL, domain information, channel specific information, program specific information, audience information, search engine, or search capabilities imprinted in the audio data.

24. The method of claim 18, further comprising:
providing verification of placement for advertising in the audio data.

25. The method of claim 18, further comprising:
displaying, in a background window, a transcription of the audio data; and
displaying, in a central window, the audio data.

26. A non-transitory computing system comprising code for execution by at least one computing processor, wherein execution of the code by the at least one processor provides:
a data layer configured to receive audio data;
an application programming interface (API) configured to be around the data layer; and the API is further configured to:
generate one or more applications based on the received audio data.

27. The system of claim 26, further configured to:
access information related to the received audio data.

28. The system of claim 27, wherein:
the accessed information comprises audience size, audience demographics, audience location, audience reach, popularity, competitive standing, or talent.

29. The system of claim 28, wherein:
the accessed information is linked to the received audio data.

30. The system of claim 26, the API layer further comprises:
tools, filters, and hooks.

31. The system of claim 26, further comprising:
wherein the generating of applications further comprises manipulating the audio data by the API layer utilizing at least one of transcriptions and metadata, geographic linking, URL, domain information, channel specific information, program specific information, audience information, search engine, or search capabilities imprinted in the audio data.

32. The system of claim 26, further configured to:
provide verification of placement of advertising in the audio data.

33. The system of claim 26, further configured to:
display, in a background window, a transcription of the audio data; and
display, in a central window, the audio data.
